(19) United States
(12) Patent Application Publication
(10) Pub. No.: US 2006/0126582 A1
(43) Pub. Date: Jun. 15, 2006

(54) Delivering data to a mobile node in idle mode

(75) Inventors: Yousuf Saifullah, Flower Mound, TX (US); Khiem Le, Coppell, TX (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/082,981

(22) Filed: Mar. 18, 2005

Related U.S. Application Data
(60) Provisional application No. 60/634,264, filed on Dec. 9, 2004.

(51) Int. Cl. H04Q 7/24; H04L 12/56; H04L 12/28

(52) U.S. Cl. 370/338; 370/395.2

(57) ABSTRACT

A method of deliveries data and to a mobile node for receiving data delivered from a packet-switched data network. A first registration of the mobile node is performed to a first network of a first access technology, and an additional second registration of the mobile node is performed to a second network of a second access technology by using an address associated with the mobile node in said first network. An interface of the mobile node towards the second network is deactivated and the mobile node is set into an idle mode of the first network. When an incoming signaling of the first network is received at the mobile node, it is used as a trigger for activating the interface to the second network. Thereby, efficient data delivery via the second access technology, for example, WLAN technology, is allowed to bring down the communications charges and yet cellular efficient power consumption is achieved in idle mode, by camping on the first access technology, for example, cellular technology.

### FIELD OF THE INVENTION

The present invention relates to a method of delivering data and to a mobile node for receiving data delivered from a packet-switched data network.

### BACKGROUND OF THE INVENTION

Mobility support for Internet devices is quite important, since mobile computing is getting more widespread. To support mobile devices, which dynamically change their access points (AP) to the Internet, the Internet Engineering Task Force (IETF) has standardized a protocol supporting mobile Internet devices, called Mobile IP. There are two versions of Mobile IP, namely Mobile IPv4, based on IPv4 (Internet Protocol version 4), and Mobile IPv6, based on IPv6 (Internet Protocol version 6). Further information on IPv6 can be obtained from IETF specification RFC 2460, 1998.

Mobile IP allows a mobile device to leave its home subnet while transparently maintaining all of its present connections and remaining reachable to the rest of the Internet. This is realized in Mobile IP by identifying each node by its static home address, regardless of its current point of attachment to the Internet. While a mobile node is away from home it sends information about its current location to a home agent (HA) on its home link. The HA intercepts packets addressed to the mobile node and tunnels them to the mobile node's present location. This mechanism is completely transparent for all layers above IP, e.g. for TCP (Transmit Control Protocol), UDP (User Datagram Protocol) and of course for all applications. Therefore, domain name server (DNS) entries for a mobile node refer to its home address and don't change if the mobile node changes its Internet access point. In fact, Mobile IP influences the routing of packets but is independent of the routing protocol itself.

The solution given by Mobile IPv6 consists of creating a so-called care-of address (CoA) whenever a node changes its point of attachment to the web. The CoA is an IP address associated with a mobile node while visiting a foreign link. Thus, basically messages that arrive at the original home address are redirected or tunneled to CoA.

Mobile IPv6 requires the exchange of additional information. All new messages used in Mobile IPv6 are defined as IPv6 destination options. These options are used in IPv6 to carry additional information that needs to be examined only by a packet destination node. In particular, a binding update option is used by a mobile node to inform its HA or any other correspondent node about its current CoA. A binding acknowledgement option is used to acknowledge the receipt of a binding update, if an acknowledgement was requested. Furthermore, a binding request option is used by any node to request a mobile node to send a binding update with the current CoA. Finally, a home address option is used in a packet sent by a mobile node to inform the receiver of this packet about the mobile node's home address. If a packet with the home address option is authenticated then the home address option must also be covered by this authentication.

The presence of multiple wireless technologies poses new problems and presents new opportunities for operators or service providers to utilize and manage resources across these technologies. Each wireless technology has its own technical capabilities and limitations. For example, WLAN (Wireless Local Area Network) as defined e.g. in the IEEE (Institute of Electrical and Electronics Engineers) specifications 802.11a, 802.11b and 802.11g does not provide for any dormancy capability or sleep mode. Thus, the mobile terminals or devices are required to continuously monitor a beacon information and other packets. This essentially drains the power resources in the terminal device. On the other hand, current cellular technologies (e.g. Global System for Mobile communication (GSM), Code Division Multiple Access (CDMA), Time Division Multiple Access (TDMA)) and 3G cellular systems (e.g. Wideband CDMA (WCDMA), CDMA2000) have dormancy capabilities allowing the terminals to conserve power by going into dormancy. The terminals wake up periodically, for a very brief time, to check the paging messages from the network to see if they are being paged for any downlink communication.

Currently there is discussion in the 3rd Generation Partnership Project (3GPP) Release 6 standard to include WLAN as part of Universal Mobile Telecommunications Services (UMTS) networks. However, using a licensed spectrum for data traffic over the cellular systems can be very expensive compared to WLAN, which uses an unlicensed spectrum. So, it is intuitive to see that in the presence of multiple technologies and devices that support them, it is cheaper or more convenient for the user or the network operator to use the cheaper or more efficient technology alternative. However, from a power consumption point of view, not all interfaces to all technologies may be active in the devices at all time. And, not all technologies will be available everywhere.

IEEE specification 802.11 has defined power saving methods without considering the mobility aspect of the terminal. This is because this standard is primarily focused on providing wireless access to terminal devices like laptop computers. These power saving methods are deficient for a mobile wearable device (e.g. voice or multi-media terminal) that changes Access Points (APs) quite frequently. Irrespective of the power saving method used, whenever a terminal goes out of the coverage of its current AP, it would continuously try to find a beacon of the new AP. After finding a beacon, it would perform WLAN Reassociation with the new AP. These procedures consume battery power. This problem is more grave for 5 GHz band WLAN systems, where the coverage area of an AP is smaller than for 2.4 GHz band WLAN systems. Thus causing a terminal to do WLAN Reassociation procedures more frequently.

A WLAN network, owned by an enterprise, requires a dual mode terminal user to be primarily reached by his address in the WLAN network. It also requires using WLAN network, not cellular network, while the terminal is in the WLAN coverage. This helps in reducing the cellular operator charges, and also helps in monitoring the user activity.

Additionally, there is a problem of cellular operator dependency. When the dual mode terminal roams into a cellular network, it can get a CoA in the cellular network and try to register it with the HA in the WLAN network (HA-wlan). The registration message is first routed to a foreign agent in the cellular network (FA-cell), and then the FA-cell forwards it to the HA-wlan. The problem is that the cellular operator could bar its FA-cell to perform Mobile IP registration with an outside HA, thus forcing an enterprise to enter into a connection agreement with the cellular operator. Although FA is optional in Mobile IPv4, it is a mandatory part of 3GPP2 architecture. The enterprise customers would however prefer a solution with an operator agnostic WLAN system.

### SUMMARY OF THE INVENTION

It is therefore an object of the present invention to provide an operator agnostic solution for delivering data packets to a mobile node in a network of a first access technology, while the mobile node is in a sleep mode of a network of a second access technology.

This object is achieved by a method of delivering data from a packet-switched network to a mobile node, said method comprising the steps of:
performing a first registration of said mobile node to a first network of a first access technology;
performing a second registration of said mobile node to a second network of a second access technology by using an address associated with said mobile node in said first network;
deactivating an interface of said mobile node towards said second network;
setting said mobile node into an idle mode of said first network; and
using an incoming signaling of said first network as a trigger for activating said interface to said second network.

Additionally, the above object is achieved by a mobile node for receiving data delivered from a packet-switched data network, said mobile node comprising:
first registration means for performing a first registration to a first network of a first access technology;
second registration means for performing a second registration of said mobile node to a second network of a second access technology by using an address associated with said mobile node in said first network;
deactivation means for deactivating an interface towards said second network; and
setting means for setting said mobile node into an idle mode of said first network;
wherein said deactivating means is configured to activate said interface to said second network in response to the receipt of an incoming signaling of said first network.

Accordingly, data traffic or data delivery is allowed on the second access technology, e.g. to bring down the communications charges, and yet efficient power consumption can be achieved in idle mode by camping on the first access technology. Moreover, by using the associated address of the first network as a care-of-address for registration to the second network, an operator agnostic solution can be provided since a special permission/provisioning in the first network is not required.

The proposed solution provides maximum utilization of the WLAN network at the same time optimal power saving without any standardization changes. The cellular network can be used without requiring any change. There is no dependency on the cellular operator, and the solution is agnostic to the cellular system. Required changes affect terminal devices only.

As an example, the first access technology may be a packet-switched (PS) cellular network access technology, and the second access technology may be a WLAN access technology. At least the second registration may be a Mobile IP registration, wherein the associated address may be used as a care-of-address of the mobile node in the second network. In idle mode, the mobile node or terminal device is registered on the PS cellular access, thus allowing incoming call set up signaling to be delivered. When the terminal receives an incoming call set up signaling, it will perform a Mobile IP registration with the WLAN access, so that the traffic is redirected to the WLAN access network.

Accordingly, the incoming signaling, e.g. a call setup signaling, can be used as a trigger to perform Mobile IP registration with the WLAN access network. A Mobile IP registration procedure is thus added with appropriate CoA and messaging on top of cellular network registration procedure, so as to make it transparent to the cellular network. Therefore, neither a specific cellular technology nor any agreement with the cellular operator is required.

As a general solution to the above problem, two access technologies are provided, wherein it is power efficient to camp on the first access technology in idle mode but it is preferable to use the second access technology for data exchange or trafficking. In the particular embodiments described later, the first access technology is a cellular PS technology and the second access technology is a WLAN technology. As a concrete example, Mobile IP is assumed for registration on the second access technology. However, other mobility schemes, like the Host Identity Payload (HIP) could be used as well.

The activation of the interface to the second network may be performed in response to an indication of access to the second network. Thereby, power efficiency can be increased, as interface activations are only triggered if the mobile node has access to the second network.

In a first example, an accepting response to the incoming signaling may be sent and delivery of the data may initially be performed via an interface to the first network before delivery is switched to the interface to the second network after completion of the triggered activation. If latency is involved in switching from e.g. a cellular network to a WLAN network, some traffic is allowed in the data network while switching is occurring. This assures fast delivery but may result in additional costs for delivery via the first network.

In an alternative second example, the incoming signaling may be rejected, e.g. by a rejecting response or by no response at all, and delivery of the data may be started via the interface to the second network after completion of the triggered activation.

The associated address may be a home address of the mobile node in the first network, or an address, e.g. care-of-address, associated with the mobile node while visiting a foreign link of the first network.

### BRIEF DESCRIPTION OF THE DRAWINGS

In the following, the present invention will be described in greater detail on the basis of preferred embodiments with reference to the accompanying drawings in which:

FIG. 1 shows a schematic flow diagram of a data delivery procedure according to the preferred embodiments;

FIG. 2 shows a schematic signaling diagram indicating MIP Registration to both HAs in cellular network and WLAN with same CoA, according to a first preferred embodiment of the present invention;

FIG. 3 shows a schematic signaling diagram indicating MIP Registration to HA in WLAN using home address of cellular network, according to a second preferred embodiment of the present invention; and

FIG. 4 shows a schematic signaling diagram indicating call alerting through cellular network followed by call delivery in the WLAN Network according to the preferred embodiments of the present invention.

### DESCRIPTION OF THE PREFERRED EMBODIMENT

The preferred embodiments will now be described on the basis of an implementation for a dual-mode terminal device (WLAN/cellular), which can receive data via a PS cellular network and via a WLAN. It is first described how an additional Mobile IP registration is done with an appropriate CoA to deliver the packets from the HA in the WLAN to a terminal roaming in the cellular network. Then, a procedure is described for session initiation/delivery through the WLAN network to a cellular dormant dual-mode terminal.

The WLAN interface of the terminal device has a Mobile IP client, and is able to register its current CoA in the WLAN HA. The cellular interface of the terminal also gets an IP address from the cellular network. The cellular network could be any packet-switched or IP-based network. It may have Mobile IP agents, e.g. it may be 3GPP2 network or 3GPP network with FA functionality on a Gateway GPRS (General Packet Radio Services) Support Node (GGSN). It may as well not have any Mobile IP agents, e.g. it may be a mere GPRS-based network. Implementation changes are required only on the terminal device. The proposed solution is applicable to both Mobile IPv4 and Mobile IPv6, and any of their fast handoff variants.

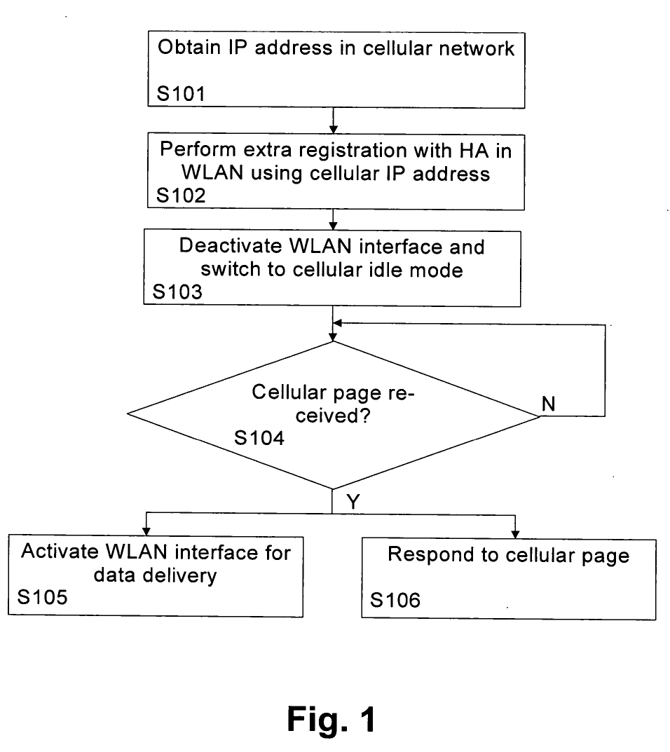

FIG. 1 shows a schematic flow diagram indication procedural steps or functions performed at the dual-mode terminal device. Initially, in step S101, the terminal device obtains an IP address in the cellular network. This IP address may be a CoA obtained during roaming in the cellular network. As an alternative, the IP address may be a static or dynamic address assigned to the terminal device, e.g., in a GPRS network. When the terminal device is in the coverage area of the WLAN, it performs in step S102 an extra or additional Mobile IP registration with the HA in the WLAN using the IP address obtained in step S101. After successful registration, the terminal device deactivates its WLAN interface and changes or switches to an idle mode, e.g. page mode, of the cellular network (step S103). Thereby, a power efficient sleeping or dormant state of the terminal device can be achieved.

The terminal device now remains in the idle state until it determines in step S104 that a paging signal or page has been received from the cellular network. In response to the detection or receipt of the cellular page, the terminal device activates its WLAN interface in step S105 for delivery of data. In parallel, it issues a response to the cellular page (step S106).

It is noted that steps S105 and S106 may be performed sequentially and in any order. It is further noted that steps S101 to S106 of FIG. 1 may be implemented as a software or program routine which can be loaded or written into a memory of the terminal device and which is configured to control an internal processor of the terminal device to execute the procedure of FIG. 1. As an alternative, steps S101 to S106 may be implemented as concrete hardware devices or components provided in the terminal device.

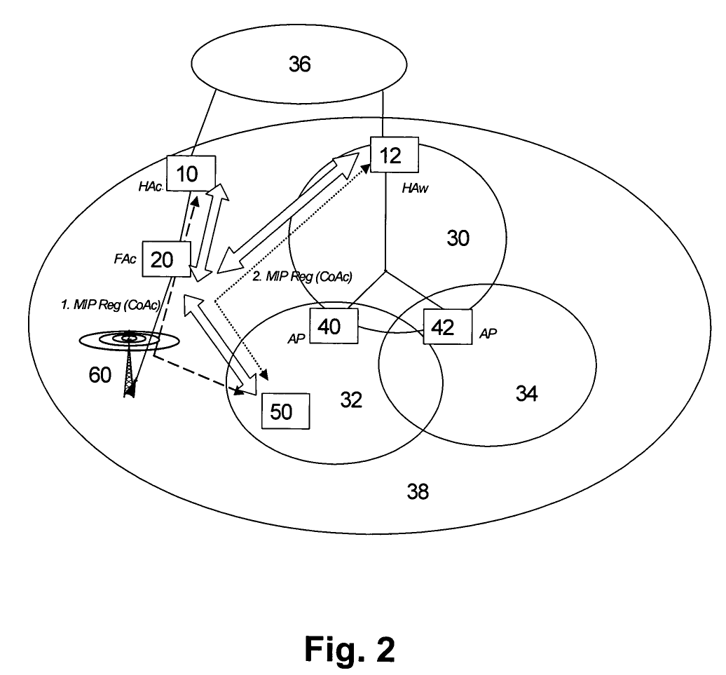

FIG. 2 shows a signaling diagram indicating MIP Registration to both HAs 10, 12 in a cellular network 38 and a WLAN 30 with same CoA, according to a first preferred embodiment, based on an overall network configuration underlying the preferred embodiments. The HAs 10, 12 provide connection to the Internet 36 for delivery of data.

The HA 12 in the WLAN network always keeps the current IP address as CoA of a dual-mode terminal device 50. The WLAN 30 and the cellular network 38 are viewed as different sub-networks by the HA 12 in the WLAN 30. When the terminal device 50 is active in the WLAN 30, it obtains the CoA in the WLAN 30 using a standard MIP procedure for getting CoA. The terminal device 50 registers this CoA with the HA 12 in the WLAN 30 using the standard MIP registration procedure. In FIG. 2, two exemplary APs 40, 42 of the WLAN 30 are shown with their respective coverage areas 32, 34. The terminal device 50 is located in the coverage area 32 of the left AP 40.

When the terminal device 50 roams into the cellular network 38, it obtains a CoA in the cellular network 38 and registers it with the HA 10 in the cellular network 38 via a cellular access network 60, such as a UMTS Terrestrial Radio Access Network (UTRAN). The procedure for obtaining the CoA depends on the type of mobility solution present in the cellular network.

In case of an Mobile IP (MIP) based cellular network, MIP could be present on top of GPRS mobility in a 3GPP network. In this case, there are two ways of obtaining the CoA. The first way is indicated in FIG. 2.

When the terminal device 50 has detected WLAN coverageit deactivates its WLAN interface, switches to cellular idle mode and stays dormant in the cellular network 38. Before it deactivates the WLAN interface, it performs the steps shown in FIG. 2. In step 1 of FIG. 2, the terminal device obtains the CoA in the cellular network 38 and performs registration with a FA 20 and the HA 10 in the cellular network 38 using regular MIP procedures (as indicated by the dashed arrows). The terminal device 50 then performs in step 2 an extra registration with the HA 12 in the WLAN 30 using the same CoA obtained from the cellular network 38 (as indicated by the dotted arrows). This will create a direct tunnel from the HA 12 in the WLAN 30 to the FA 20 in the cellular network (as indicated by the bold arrow). Data packets received by the HA 12 of the WLAN 30, e.g. from the Internet 36, are thus tunneled through the FA 20 in the cellular network 38. In this case, the CoA in both networks is the same.

This approach leads to the result that the first registration with the HA 10 in the cellular network 38 (step 1) would allow some data packets to arrive at the terminal device 50 through the HA 10 in the cellular network 38 without any involvement of the WLAN network 30. However, this might not be desirable for WLAN network administrators.

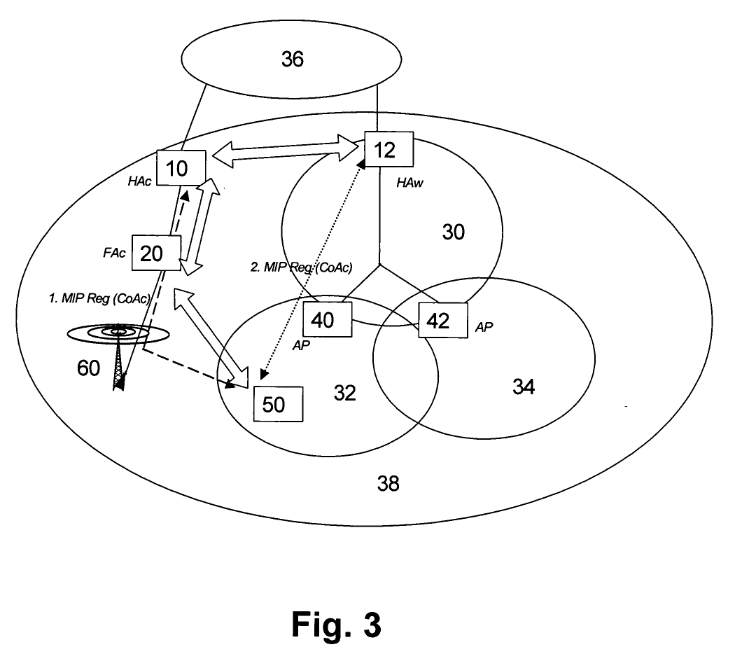

FIG. 3 shows a schematic signaling diagram indicating MIP Registration to the HA 12 in the WLAN 30 using a home address of the cellular network 38, according to a second preferred embodiment.

After the terminal device 50 has detected WLAN coverage and has obtained a CoA in the cellular network 38, it performs registration with the FA 20 and HA 10 in the cellular network 38 using regular MIP procedures (step 1). Then, in step 2, the terminal device 50 performs an extra or additional registration with the HA 12 in the WLAN 30 using now its home address in the cellular network 38 as CoA in the WLAN 30. In this case, the CoAs in the two networks are different. This will create an additional tunnel between the HA 12 in the WLAN 30 and the HA 10 in the cellular network 38 (as indicated by the bold arrow), so that the data packets to be delivered are now tunneled to the HA 10 after step 2.

On the other hand, in case of a GPRS Network without MIP procedures, the GPRS network assigns a static or dynamic IP address to the terminal device 50. The terminal device 50 uses the GPRS assigned IP address as CoA and performs registration directly with the HA 12 in the WLAN 30. This creates a tunnel between the HA 12 in the WLAN 30 and the allocated GGSN of the GPRS network. The dta packets between the GGSN and the terminal device 50 will then be exchanged using a GPRS tunnel.

In the following, a procedure for the dual mode terminal device 50 is described for packet delivery or trafficking in the WLAN 30, while staying dormant in the cellular network 38. An idle terminal that doesn't have any traffic to exchange always stays dormant in the cellular network 38. It registers its CoA obtained from the cellular network 38 with the HA 12 in the WLAN 30, as explained above.

When the dual mode terminal device 50 has detected presence of the WLAN coverage, it sets an internal state “WLAN Network is present”. This may be achieved by setting an internal flag memory or a register of the terminal device 50 to a predetermined value. Then, the terminal device 50 first activates its WLAN interface. It performs a WLAN Association procedure with the AP 40, even if it doesn't have any packet to send or receive. It may also perform Mobile IP registration in the WLAN 30. The security procedure triggered by the WLAN association and MIP registration may involve message and security key exchange with other network elements, e.g. an AAA network (not shown). Therefore, performing the security procedures outside of a session establishment procedure is useful in reducing the latency during the session establishment. It also avoids unnecessary activation of the WLAN interface in response to the receipt of a page message when there is no WLAN coverage.

After performing the WLAN Association, the terminal device 50 deactivates its WLAN interface. It activates the cellular interface and goes into paging mode or idle mode.

The packet transmission or trafficking from the dual-mode terminal device 50 through the WLAN 30 involves only the terminal device 50 itself. When the terminal device 50 needs to send a packet, it will turn on the WLAN interface when it is in “WLAN Network is present” state. It will perform WLAN Association, obtain CoA in the WLAN 30 and performs MIP registration with the HA 12 in the WLAN 30. After that it will exchange packets through the WLAN 30.

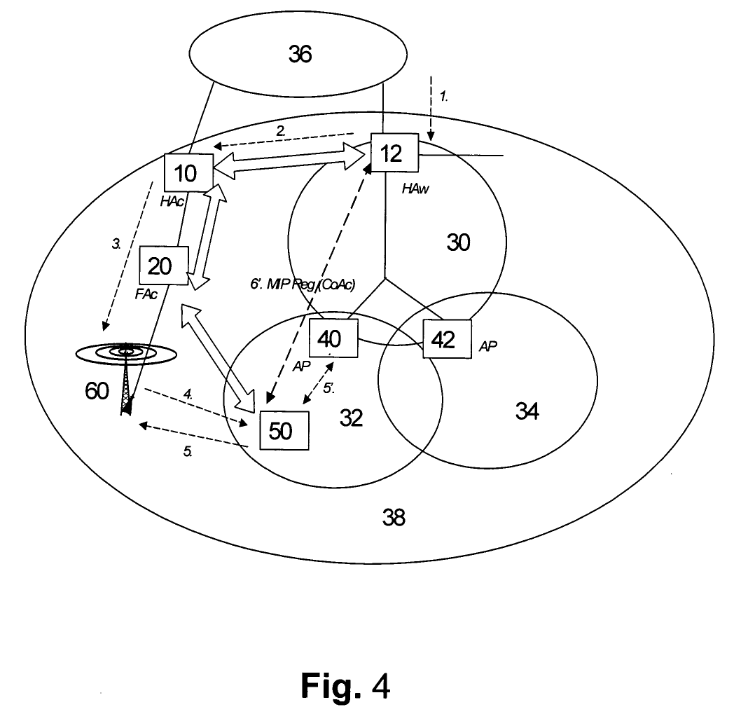

FIG. 4 shows a schematic signaling diagram indicating call alerting through the cellular network 38 followed by call delivery in the WLAN 30.

The terminal device 50 is known to the external world, e.g. the Internet 36, by its home address in the WLAN 30. When an IP data packet is sent to the terminal device 50 by a remote end point in step 1, it is first received by the HA 12 in the WLAN 30. The HA 12 in the WLAN 30 forwards the packet to the registered CoA, which is the home address in the cellular network 38 (step 2). The HA 10 in the cellular network 38 receives the data packet and forwards it to the CoA it has registered. This directs the packet via the FA 20 to the cellular access network 60 (step 3). The cellular access network 60 initiates a page to the terminal device 50 (step 4). In response to the receipt of the page, the terminal device 50 may check the “WLAN Network is present” state. If it is set, it activates the WLAN interface. It performs the WLAN Association procedure with the AP 40 of its coverage area 32 (step 5′), followed by a MIP registration with the CoA which corresponds to the allocated IP address of the WLAN (step 6′). At the same time, while it is performing the procedures on the WLAN interface, it may also respond to the page.

The following two options may be available for responding to the page:

According to the first option, the terminal device may send a page accept response and start exchanging the traffic or receiving the delivered data packets via its cellular interface. When the MIP registration is completed on the WLAN interface, the HA 12 in the WLAN 30 may automatically switch the traffic to the WLAN interface. At this point, the terminal device 50 releases the cellular interface and keeps the WLAN interface active. This option is illustrated in FIG. 4. It may allow some data traffic transfer on the cellular interface until the HA 12 in the WLAN 30 performs switching. This may lead to some costs charged by the cellular operator.

According to the second option, the terminal device 50 may wait for a successful WLAN Association and may send page reject response on its cellular interface. This option will not incur any costs by the cellular operator. For example, in a cdma2000 system, the terminal device 50 may send a page response with null service option to indicate that it is not interested in the call. Sending of the reject response is however totally optional. The terminal device 50 may even not send any response to the page at all. The cellular network 38 will eventually timeout for the page response.

If the terminal device 50 doesn't succeed in the WLAN association, it may send page response on its cellular interface and may proceed with the session on the cellular interface.

Both above options are valid. If an enterprise doesn't care about small cellular operator charges, then the first option provides faster packet delivery to the terminal device 50. Although, at the session initiation time a faster delivery not necessarily is a requirement.

In summary, a method of delivering data and a mobile node (terminal device 50) for receiving data delivered from a packet-switched data network has been described. A first registration of the mobile node is performed to a first network (cellular network 38) of a first access technology, and an additional second registration of the mobile node is performed to a second network (WLAN 30) of a second access technology by using an address associated with said mobile node in said first network. Then, an interface of the mobile node towards the second network is deactivated and the mobile node is set into an idle mode of the first network. When an incoming signaling of the first network is received at the mobile node, it is used as a trigger for activating the interface to the second network. Thereby, efficient data delivery via the second access technology, e.g. WLAN technology, is allowed to bring down the communications charges and yet cellular efficient power consumption is achieved in idle mode, by camping on the first access technology, e.g., cellular technology.

It is noted, that the present invention is not restricted to the specific preferred embodiments described above, but can be used in connection with any multi-mode terminal capable of providing access to several networks of different access technology. In particular, any registration scheme may be used, by means of which data can be tunneled or routed through one of the networks. The preferred embodiments may thus vary within the scope of the attached claims.

1. A method of delivering data from a packet-switched network to a mobile node, said method comprising the steps of:
a) performing a first registration of a mobile node to a first network of a first access technology;
b) performing a second registration of said mobile node to a second network of a second access technology by using an address associated with said mobile node in said first network;
c) deactivating an interface of said mobile node towards said second network;
d) setting said mobile node into an idle mode of said first network; and
e) using an incoming signaling of said first network as a trigger for activating said interface to said second network.

2. The method according to claim 1, wherein said first access technology comprises a packet-switched cellular network access technology.

3. The method according to claim 1, wherein said second access technology comprises a wireless local area network access technology.

4. The method according to claim 1, wherein said idle mode comprises a paging mode.

5. The method according to claim 1, wherein said incoming signaling comprises a call setup paging signaling.

6. The method according to claim 1, wherein at least said second registration comprises a mobile IP registration, and wherein said address is used as a care-of-address of said mobile node in said second network.

7. The method according to claim 1, further comprising the step of performing an activation of said interface to said second network in response to an indication of access to said second network.

8. The method according to claim 1, further comprising the steps of sending an accepting response to said incoming signaling;
starting delivery of data via said interface to said first network; and
switching to said interface to said second network after completion of a triggered activation.

9. The method according to claim 1, further comprising the steps of rejecting said incoming signaling, and
starting delivery of data via said interface to said second network after completion of a triggered activation.

10. The method according to claim 9, wherein said rejecting step comprises sending a rejecting response or no response.

11. The method according to claim 1, wherein said address comprises a home address of said mobile node in said first network. 12. The method according to claim 1, wherein said address is an address associated with said mobile node while visiting a foreign link of said first network.

12. A mobile node for receiving data delivered from a packet-switched data network, said mobile node comprising:
a) first registration means for performing a first registration to a first network of a first access technology;
b) second registration means for performing a second registration of said mobile node to a second network of a second access technology by using an address associated with said mobile node in said first network;
c) deactivation means for deactivating an interface towards said second network; and
d) setting means for setting said mobile node into an idle mode of said first network;
wherein said deactivating means is configured to activate said interface to said second network in response to a receipt of an incoming signaling of said first network.

13. The mobile node according to claim 12, wherein said first access technology comprises a packet-switched cellular network access technology.

14. The mobile node according to claim 12, wherein said second access technology comprises a wireless local area network access technology.

15. The mobile node according to claim 12, wherein said idle mode comprises a paging mode.

16. The mobile node according to claim 12, wherein said incoming signaling comprises a call setup paging signaling.

17. The mobile node according to claim 13, wherein at least said second registration means is configured to perform a mobile IP registration by using said address as a care-of-address of said mobile node in said second network.

18. A mobile node according to claim 12, wherein said deactivating means is configured to perform an activation of said interface to said second network in response to an indication of access to said second network.

19. The mobile node according to claim 12, wherein said deactivating means comprises sending means for sending an accepting response to said incoming signaling,
means for starting receipt of data via said interface to said first network, and
releasing means for releasing said interface to said first network after completion of a triggered activation.

20. The mobile node according to claim 12, wherein said deactivating means comprises rejecting means for rejecting said incoming signaling, and starting means for starting receipt of data via said interface to said second network after completion of said triggered activation.

21. The mobile node according to claim 20, wherein said rejecting means is configured to send a rejecting response or no response.

22. The mobile node according to claim 12, wherein said address comprises a home address of said mobile node in said first network.

23. The mobile node according to claim 12, wherein said address comprises an address associated with said mobile node while visiting a foreign link of said first network.

24. A computer program embodied on a computer-readable medium, said computer program, when run by a computer or mobile node, to perform the steps of:
performing a first registration of a mobile node to a first network of a first access technology;
performing a second registration of said mobile node to a second network of a second access technology, by using an address associated with said mobile node in said first network;
deactivating an interface of said mobile node towards said second network;
setting said mobile node into an idle mode of said first network; and
using an incoming signaling of said first network as a trigger for activating said interface to said second network.
